(19) United States
(12) Patent Application Publication
(10) Pub. No.: US 2019/0220827 A1
(43) Pub. Date: Jul. 18, 2019

(54) DISRUPTION CONTROL IN COMPLEX SCHEDULES

(71) Applicant: International Business Machines Corporation, Armonk, NY (US)

(72) Inventors: Randall Lee Cogill, Dublin (IE); Jakub Marecek, Dublin (IE); Martin Mevissen, Dublin (IE); Robert Shorten, Dublin (IE); Sergiy Zhuk, Dublin (IE)

(21) Appl. No.: 15/874,402

(22) Filed: Jan. 18, 2018

(51) Int. Cl. G06Q 10/10; G06Q 10/06; G06F 17/18

(52) U.S. Cl. CPC G06Q 10/1097; G06Q 10/06312; G06F 17/18; G06Q 10/0635; G06Q 10/06316

(57) ABSTRACT

Techniques are described that facilitate disruption control in complex schedules comprising a plurality of interdependent tasks. In one embodiment, a computer-implemented method comprises forecasting, by a device operatively coupled to a processor, probability distributions of time delays added to respective tasks of a complex schedule using a stochastic model for the respective tasks, current delay information associated with the respective tasks, and one or more defined mitigating actions that reduce or eliminate time delay attributed to a delay component of the stochastic model. The method further comprises, determining, by the device, loss information regarding losses, wherein losses can include costs attributed to the time delays and costs related to the one or more defined mitigating actions. The method can further comprise determining, by the device, a recommendation regarding implementation of the one or more defined mitigating actions based on the loss information.

### TECHNICAL FIELD

This application relates to proactively controlling potential disruptions to a complex schedule in real-time based on conditional probability distributions of the potential disruptions, given previous disruptions or a state of the system related to the previous disruptions.

### SUMMARY

The following presents a summary to provide a basic understanding of one or more embodiments of the invention. This summary is not intended to identify key or critical elements, or delineate any scope of the different embodiments or any scope of the claims. Its sole purpose is to present concepts in a simplified form as a prelude to the more detailed description that is presented later. In one or more embodiments described herein, systems, computer-implemented methods, apparatus and/or computer program products are presented that provide for proactively controlling potential disruptions to a complex schedule in real-time based on a probability distribution of the potential disruptions.

According to an embodiment of the present invention, a system can comprise a memory that stores computer executable components and a processor that executes the computer executable components stored in the memory. The computer executable components can comprise a delay forecasting component that forecasts a probability distribution of time delays added to a task of a complex schedule using a stochastic model for the complex schedule, information regarding a current state of a system operating in accordance with the complex schedule or previous delays, a distribution of the delay associated with the task, and one or more defined mitigating actions that reduce or eliminate a delay component of the stochastic model. The computer executable components can further comprise a risk analysis component that determines loss information regarding losses associated with the time delays, and a response recommendation component that determines a recommendation regarding implementation of the one or more defined mitigating actions based on the loss information. In various implementations, the response recommendation component can further determine the recommendation regarding implementation of the one or more defined mitigating actions based on the probability distribution of the time delays.

In some implementations, the delay component comprises a reactionary delay component that is function of end times of tasks preceding the task and a root-cause delay component that is an independent random process specific to a resource affecting the task utilized at a specific time. Respective tasks of the plurality of interdependent tasks can be characterized as being interdependent because commencement of at least one or more first tasks of the plurality of interdependent tasks is dependent on completion of at least one or more second tasks of the plurality of interdependent tasks. In some implementations, the losses can include costs associated with the delays and costs of mitigation actions and the loss information can comprise a probability distribution of the costs conditional on the delays.

In association with determining the probability distribution of the time delays, the delay forecasting component can determine a probability distribution of start time delays added to the scheduled start time of the task as a combination of the reactionary delay component, the root-cause delay component, and the one or more defined mitigating actions. The delay forecasting component can further determine a probability distribution of end time delays added to the scheduled end time as a combination of the reactionary delay component, the root-cause delay component and the one or more defined mitigating actions. With these implementations, the risk analysis component can determine the loss information based on start costs associated with the start time delays, end costs associated with the end time delays, and mitigation costs associated the one or more defined mitigating actions.

The risk analysis component can further determine a mitigating action of the one or more defined mitigating actions that minimizes the expected losses. For example, the risk analysis component can employ a dynamical programming (DP) or an approximate dynamical programming (ADP) methods to determine a mitigating action or combination of mitigating actions that best minimizes the expected losses. The response recommendation component can further recommend the mitigating action for implementation based on the mitigating action being determined to minimize the expected losses, or some other risk measure of the losses. In one implementation, the mitigating action can correspond to a cancelation of the task, and the computer executable components can further comprise an execution component that cancels the task and updates the complex schedule in real-time to reflect the cancelation of the task based on a determination that the cancelation of the task minimizes the expected losses.

In some implementations, the stochastic model comprises or employs one or more Markov models. In this regard, the stochastic model can comprise a Markov model that was trained using machine-learning techniques known as Hidden Markov Modelling (HMM) based on historical schedule and delay data associated with the complex schedule. In one example implementation, the complex schedule can comprise a flight schedule of one or more aircrafts over a defined period of time, such as a single calendar day. According to this example, the task can comprise flight of an aircraft from a first airport to a second airport, and the scheduled start time can correspond to the scheduled departure time of aircraft from the first airport to the second airport and the scheduled end time can correspond to the scheduled arrival of the aircraft at the second airport.

In some embodiments, elements described in connection with the disclosed systems can be embodied in different forms such as a computer-implemented method, a computer program product, or another form.

### DESCRIPTION OF THE DRAWINGS

FIG. 1 illustrates a block diagram of an example, non-limiting system that facilitates proactively controlling potential disruptions to a complex schedule in real-time based on a probability distribution of the potential disruptions in accordance with one or more embodiments of the disclosed subject matter.

FIG. 2 presents a flow diagram of an example, non-limiting computer-implemented process for controlling potential disruptions to a complex schedule in real-time based on a probability distribution of the potential disruptions in accordance with one or more embodiments of the disclosed subject matter.

FIG. 3 illustrates a block diagram of another example, non-limiting system that facilitates proactively controlling potential disruptions to a complex schedule in real-time based on a probability distribution of the potential disruptions in accordance with one or more embodiments of the disclosed subject matter.

FIG. 4 provides a high-level flow diagram of an example dynamical programming function that can be employed to determine costs attributed to start time delays to tasks of a complex schedule in accordance with one or more embodiments of the disclosed subject matter.

FIG. 5 provides a high-level flow diagram of another example approximate dynamical programming function that can be to determine costs attributed to start time delays to tasks of a complex schedule in accordance with one or more embodiments of the disclosed subject matter.

FIG. 6 provides a high-level flow diagram of an example dynamical programming function that can be employed to determine one or more mitigating actions that minimize expected costs attributed to start time delays to tasks of a complex schedule in accordance with one or more embodiments of the disclosed subject matter.

FIG. 7 provides a high-level flow diagram of another example approximate dynamical programming function that can be employed to determine one or more mitigating actions that minimize expected costs attributed to start time delays to tasks of a complex schedule in accordance with one or more embodiments of the disclosed subject matter.

FIG. 8 illustrates a block diagram of another example, non-limiting system that facilitates proactively controls potential disruptions to a complex schedule in real-time based on a probability distribution of the potential disruptions in accordance with one or more embodiments of the disclosed subject matter.

FIG. 9 illustrates an example non-limiting computer-implemented process for proactively controlling potential disruptions to a complex schedule in real-time based on a probability distribution of the potential disruptions in accordance with one or more embodiments of the disclosed subject matter.

FIG. 10 illustrates another example non-limiting computer-implemented process for proactively controlling potential disruptions to a complex schedule in real-time based on a probability distribution of the potential disruptions in accordance with one or more embodiments of the disclosed subject matter.

FIG. 11 illustrates another example non-limiting computer-implemented process for proactively controlling potential disruptions to a complex schedule in real-time based on a probability distribution of the potential disruptions in accordance with one or more embodiments of the disclosed subject matter.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Summary section or in the Detailed Description section.

The subject disclosure provides systems, computer-implemented methods, apparatus and/or computer program products that facilitate proactively controlling potential disruptions to complex schedules in real-time based on a probability distribution of the potential disruptions. Schedule disruptions are a significant source of unplanned costs in various transport systems, such as airline systems, railway systems, bus systems, and the like. While an arrival time and departure time may be scheduled or planned, in certain cases the aircraft, train, bus, etc., may arrive later than scheduled and thus depart later than scheduled. These delays can have ramifications such as causing other delays that can propagate throughout an entire system. The cost of some types of delays may be minimal while other types of delays may cause multiple delays throughout an entire system and thus be very costly. For example, with respect to the airline industry, a delayed flight departure can result in passengers missing connections, resulting in costs associated with rebooking passengers, loss of future business from disgruntled passengers, and the like. Further, as the aircraft continues operation until the end of the day, an early delay associated with one leg or flight can propagate throughout subsequent legs, resulting in many disruptions that are compounded over time.

One or more embodiments of the disclosed subject matter are directed to a system that employs one or more disruption models to predict, based on current data indicating current time delays to one or more tasks of a complex schedule including a plurality of interrelated tasks, a distributional forecast of future disruptions or delays to downstream tasks of the complex schedule. In this regard, the disruption models can include stochastic models (hereinafter referred to as stochastic disruption models) that estimate probabilities of potential delays to respective tasks of complex schedules rather than scalar values representative of the delay times. Based on the distributional forecast of future delays, the system can further determine or infer, in real-time, predicted losses (e.g., negative financial and/or service impacts) associated with the future delays and one or more responses for mitigating the predicted losses based on the disruptions or delays.

For example, in association with evaluating a particular flight scheduled in the near future, it might be the case that a departure delay under 30 minutes for this flight will incur relatively little cost to the airline, but a delay exceeding 30 minutes could be very costly due to missed passenger connections, missed departure gates at the airport, crew overtime, and the like. The disclosed techniques can determine and consider the degree of uncertainty with respect to how likely a potential delay will be and further determine whether and what response to take based on the degree of uncertainty. In furtherance to the above airline example, the disclosed system can determine for example that there is 35% chance of a delay over 30 minutes, and further weigh the potential cost and risk of performing versus not performing different mitigating actions to recover from the potential delay. For example, the mitigating actions could include canceling the flight, rescheduling certain passengers for an alternative flight, swapping the aircraft equipment assigned to this flight, speeding up a preceding flight at a higher fuel cost than scheduled, and the like. This type of loss/risk analysis is not afforded by a mere prediction that a flight is expected to be N minutes late.

In this regard, in various embodiments, the disclosed systems can use one or more stochastic disruption models for the respective tasks of a complex schedule, current delay data, and a loss/cost model as input, and determine one or more mitigating actions (or one or more combinations of mitigating actions), that minimize expected losses attributed to delays based in part on the distributional forecast of the delays. The type of losses can vary based on the type of system and complex schedule that is evaluated using the disclosed techniques. For example, with respect to an airline schedule, the disclosed systems can determine a combination of flight cancelations and/or flight speed increases (at the cost of burning extra fuel, wear and tear on the aircraft, etc.) that minimize expected losses that are a combination of the costs of the delays and the costs of the mitigating actions. The losses can be determined based on a defined cost model that identifies costs associated with start time delays, costs associated with arrival time delays, and costs associated with performance of the respective mitigating actions (e.g., costs associated with re-booking passengers on alternate flights, cost associated with burning extra fuel, etc.). Further, because the delays can be determined as a probability distribution of a random variable, the disclosed systems can provide probability distributions of the losses associated with the respective delays. For example, with respect to costs attributed to potential delays of an airline schedule, the disclosed systems can determine information such as a probability the airline will incur more than N dollars in losses for the operation of the airline's aircrafts over a defined period of time (e.g., from start to finish of a defined schedule), or the average losses incurred within a certain proportion of the worst possible outcomes (also known as the expected shortfall or the conditional value at risk (CVaR)).

In some implementations, the disclosed systems can further communicate with other systems and devices to automatically execute a mitigating action that has been determined to minimize a loss associated with an anticipated delay. For example, with respect to an airline schedule, the disclosed systems can communicate with a scheduling system for the airline and automatically cancel flights. In another example, the disclosed systems can communicate with an aircraft or its flight management system and direct and/or cause the pilot or the flight management system to adjust the speed of the aircraft in accordance with a speed adjustment determined to minimize a risk measure of the losses.

Although various embodiments of the subject disclosure are described in association with controlling potential disruptions to complex schedules of transportation systems (e.g., airline systems, railway systems, bus systems, etc.), the disclosed techniques can be applied to various systems that involve performance of interdependent tasks with scheduled start times and durations (or scheduled end times). The tasks can be considered interdependent because commencement of at least some of the tasks is based on completion of at least some preceding tasks (e.g., the departure time of a second flight leg of an aircraft from an airport is based on the arrival time of the aircraft at the airport from the first flight leg). In this regard, the disclosed techniques can be applied to various types of schedules that include two or more tasks with defined start times and durations (or end times), wherein at least some of the tasks have dependencies on one another and/or on shared resources of the system (e.g., aircrafts, crew, etc.). For example, in addition to complex schedules for transportation systems, the disclosed techniques can be employed in association with controlling potential disruptions to complex schedules employed by computer software systems, computer network systems, computer software/networking systems, manufacturing systems that employ defined schedules in association with manufacturing a work product, and the like.

As used herein, the term “real-time” reflects occurrence of a second event immediately following occurrence of a first event such that the first event and the second event essentially seem to occur at the same time. In this regard, determination of predicted losses and one or more responses for mitigating the predicted losses in real-time as described herein can correspond to determination of the predicted losses and one or more responses to the predicted losses immediately following reception of the current delay data. For example, the predicted losses and the one or more responses to the predicted losses can be determined within seconds (e.g., less than 60 seconds in one embodiment, less than 2 milliseconds in another embodiment, less than 2 seconds in another embodiment, etc.) of reception of the current delay information. It should be appreciated that delay between reception of the current delay data and the determinations made based on the current delay data can vary based on the processing speed of the computing system employed.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

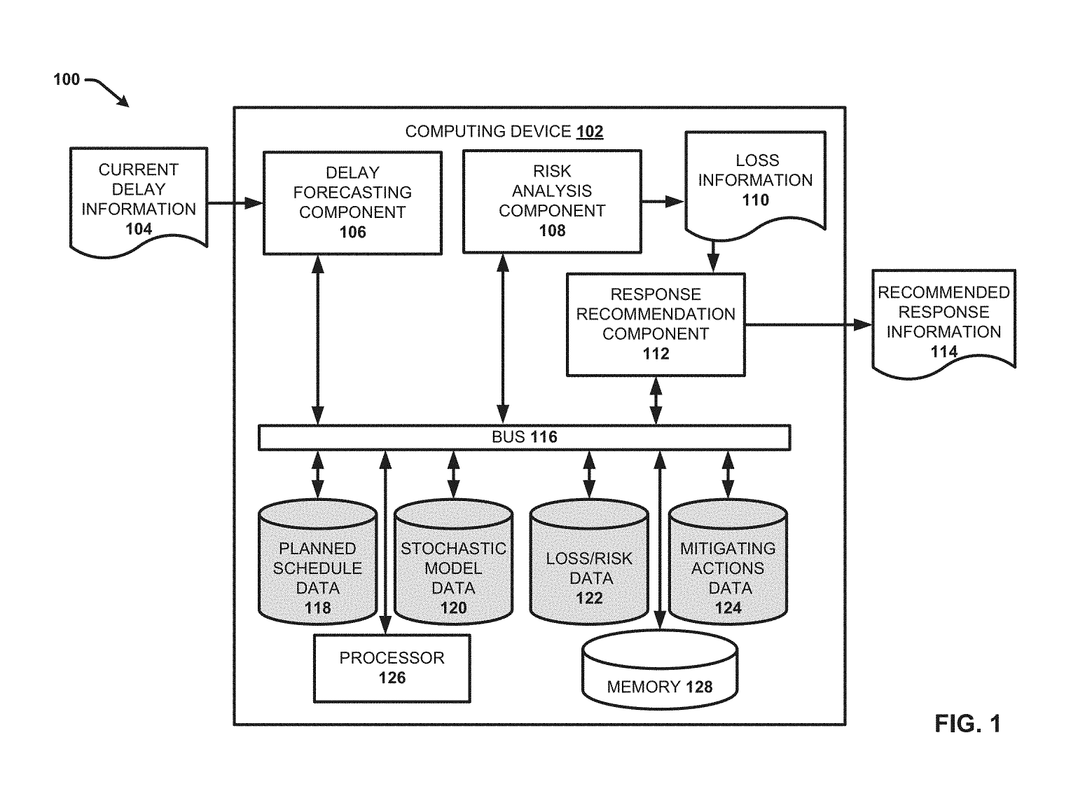

Turning now to the drawings, FIG. 1 illustrates a block diagram of an example, non-limiting system 100 that facilitates proactively controlling potential disruptions to a complex schedule in real-time based on a probability distribution of the potential disruptions, in accordance with one or more embodiments of the disclosed subject matter. System 100 and other systems detailed herein can provide substantial technical improvements in association with forecasting potential delays to complex schedules and automatically determining and implementing mitigating actions that control the propagation of losses associated with the potential delays.

In particular, system 100 and/or the components of system 100 (and other systems disclosed herein) can be employed to use hardware and/or software to solve problems that are highly technical in nature, that are not abstract, and that cannot be performed as a set of mental acts by a human. For example, a human could not possibly automatically (e.g., within a matter of seconds or less) and consistently evaluate a complex schedule involving a plurality of interrelated tasks (such as an airline schedule in its entirety), and predict potential disruptions to the schedule, especially wherein the potential disruptions are historically random events (e.g., root-cause delays as discussed infra). The disclosed techniques further provide embodiments that perform and employ a cost/risk analysis regarding whether and which mitigating actions to implement to control the propagation of future disruptions based on probability distributions of time delays and costs attributed to the time delays as opposed to merely scalar values. Further, one or more embodiments of the disclosed systems employ an approximate dynamical programming to determine mitigating actions or mitigating actions combinations that minimize expected losses attributed to delays. As a result, the mitigating actions and/or mitigating action combinations can be determined with significantly increased or enhanced processing speeds, thereby facilitating automated control over the propagation of delays in complex schedules in real-time. Further, by employing approximate dynamical programming, the disclosed systems can enhance the speed with which a processor can determine mitigating actions that minimize costs to large scale, discrete time multistage stochastic control processes, such airline systems that follow complex schedules involving hundreds of aircrafts, airports, and many tasks with complex interdependencies. System 100 and/or components of system 100 or other systems described herein can also be employed to solve new problems that arise through advancements in technology, computer networks, the Internet, and the like. For example, system 100 and/or components of system 100 (and other systems described herein) provide for automatically determining mitigating actions in real-time based on machine learning analysis of historical data. In another example, system 100 and/or components of system 100 (and other systems described herein) can causes machines to automatically execute the mitigating action to reduce or eliminate expected losses attributed to anticipated schedule disruptions in real-time.

Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. For example, in the embodiment shown, system 100 includes a computing device 102 that includes a delay forecasting component 106, a risk analysis component 108 and a response recommendation component 112, which can respectively correspond to machine-executable components. System 100 also includes various electronic data sources and data structures comprising information that can be read by, used by and/or generated by the delay forecasting component 106, the risk analysis component 108 and/or the response recommendation component 112. For example, these data sources and data structures can include but are not limited to: current delay information 104, loss information 110, recommended response information 114, planned schedule data, stochastic model data 120, loss/risk data 122, and mitigating actions data 124.

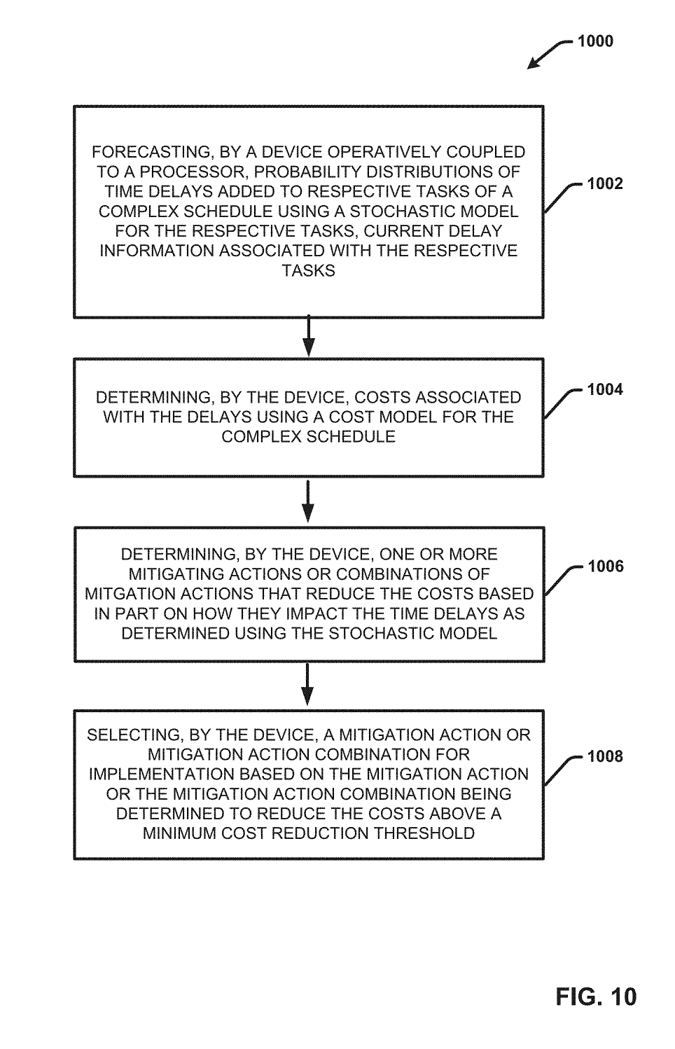

The computing device 102 can include or be operatively coupled to at least one memory 128 and at least one processor 126. The at least one memory 128 can further store executable instructions (e.g., the delay forecasting component 106, the risk analysis component 108 and the response recommendation component 112) that when executed by the at least one processor 126, facilitate performance of operations defined by the executable instruction. In some embodiments, the memory 128 can also store the various data sources and/or structures of system 100 (e.g., the current delay information 104, the loss information 110, the recommended response information 114, the planned schedule data, the stochastic model data 120, the loss/risk data 122, the mitigating actions data 124, and the like). In other embodiments, the various data sources and structures of system 100 can be stored in other memory (e.g., at a remote device or system), that is accessible to the computing device 102 (e.g., via one or more networks). The computing device 102 can further include a device bus 116 that communicatively couples the various components and data sources of the computing device 102 (e.g., the delay forecasting component 106, the risk analysis component 108 and the response recommendation component 112, the loss information 110, the planned schedule data, the stochastic model data 120, the loss/risk data 122, the mitigating actions data 124, the processor 126 and the memory 128). Examples of said processor 126 and memory 128, as well as other suitable computer or computing-based elements, can be found with reference to FIG. 10, and can be used in connection with implementing one or more of the systems or components shown and described in connection with FIG. 1 or other figures disclosed herein.

In some implementations, the computing device 102, and/or the various components and data sources of system 100 can be communicatively connected via one or more networks. Such networks can include wired and wireless networks, including but not limited to, a cellular network, a wide area network (WAD, e.g., the Internet) or a local area network (LAN). For example, the computing device 102 can communicate with an external device providing the current delay information, and/or another external device to which the recommended response information 114 is provided, (and vice versa), using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, Wireless HART protocol, 6LoWPAN (IPv6 over Low power Wireless Area Networks), Z-Wave, an ANT, an ultra-wideband (UWB) standard protocol, and/or other proprietary and non-proprietary communication protocols. The computing device 102 can thus include hardware (e.g., a central processing unit (CPU), a transceiver, a decoder), software (e.g., a set of threads, a set of processes, software in execution) or a combination of hardware and software that facilitates communicating information between the computing device 102 and externals systems, sources and devices.

In various embodiments, the delay forecasting component 106 can employ one or more stochastic disruption models developed for a complex schedule comprising a plurality of interrelated task to determine probability distributions of time delays added to each (or in some implementations one or more) scheduled task as a function of current delay information 104 associated with the respective tasks and a defined schedule that defines the planned start times and end times of the respective tasks. In this regard, based on current delay information 104 regarding current time delays affecting the task and planned schedule information, using the stochastic disruption model, the delay forecasting component 106 can determine probability distributions of time delays to start time of the task and the end time of the task. In this regard, a probability distribution of time delays can include different delay time amounts and probabilities associated with the different delay time amounts indicating the likelihood that the amount of delay will occur. For example, a probability distribution of time delays to a start time of a task could include a determination of a 10% chance of a delay of about 5.0 minutes, a 20% chance of a delay of about 15 minutes, 50% chance of a delay of about 30 minutes, a 30% chance of a delay of about 45 minutes, a 10% chance of a delay of about 55 minutes, and a 5% chance of a delay greater than 1.0 hour. In this regard, the stochastic disruption model employed by the delay forecasting component 106 can be configured to account for a level of uncertainty associated with predicting future delays to tasks of a complex schedule that is inherit in any complex schedule prone to least some unpredictable or random causes of the delay (e.g., reflected by the root-cause delays discussed below).

In the embodiment shown, the defined schedule information that defines the planned start times and end times of respective tasks included in a complex schedule can be included in the planned schedule data 118. The planned schedule data 118 for a complex schedule can also include information describing dependencies of the scheduled tasks on one another and on the resources used for the respective tasks. The stochastic disruption model for the complex schedule and associated learned noise term values (or functions and associated data for determining the noise term values) can be provided in the stochastic model data 120.

The subject stochastic disruption models employed by the delay forecasting component 106 can be configured to evaluate substantially any system that involves performance of a plurality of tasks (e.g., two or more) with scheduled or defined start times and end times (or durations), wherein at least some of the tasks can only commence when certain other tasks are complete, and wherein the tasks can become delayed due to various causes. In accordance with one or more embodiments of the subject disclosure, delays to at least some of the tasks of the complex schedule can result in losses to the system. Some example systems for which the subject stochastic disruption model can be developed and applied (e.g., by the delay forecasting component 106) include transportation systems (e.g., airline systems, railway systems, bus systems, etc.). For example, with respect to an airline system, the scheduled tasks can include scheduled flights and the complex schedule can comprise two or more scheduled flights over a defined period of time. For instance, the complex schedule can include all flights scheduled for a single aircraft over the course of a day. In another example, the complex schedule can include all flights scheduled for a single airline carrier arriving and departing from a particular airport over the course of a day. In another example, the complex schedule can include all flights scheduled for a single airline carrier arriving and departing from a set of airports. In accordance with these examples, the delay forecasting component 106 can employ a stochastic disruption model developed for the airline schedule to determine a probability distribution of delays added to scheduled departure times and/or scheduled arrival times of each (or in some implementations one or more) flight included in a defined flight schedule (e.g., defined in the planned schedule data 118) based on the defined flight schedule and current delay information 104 regarding current time delays affecting the schedule.

As described herein, a delay to a task can refer to an unanticipated change to the scheduled start time and/or end time (or duration) of a task. In accordance with various embodiments of the subject disclosure, a delay can be characterized as either a root-cause delay or a reactionary delay. Root-cause delays refer to delays attributed to an independent random process specific to one or more resources utilized for one or more tasks at a specific time. In this regard, root-cause delays result even when all predecessor tasks are complete. For example, with respect to an airline system that involves defined schedules of one or more aircrafts over the course of a defined period of time (e.g., a 24-hour period), a root-cause delay can include delay based on severe weather at the airport requiring larger separation distances, delay based on equipment breaking, delay based on a security threat at the airport, and the like. The airline industry for example has several (e.g., hundreds) of defined delay codes that correspond to known types of root-cause delays. However, it should be appreciated that various new types of root-cause delays can arise over time. Reactionary delays correspond delays that are a function of previous task end times. In this regard, a reactionary delay results from a delay in a predecessor task. For example, with respect to an airline system, a reactionary delay can include delay attributed to late arrival of an aircraft, delay attributed to missed connections for crew based on the late arrival, and the like. In one or more implementations, reactionary delays are dependent on root-cause delays.

In various embodiments, the stochastic disruption model (e.g., included in the stochastic model data 120) employed by the delay forecasting component 106 to determine probabilities of delays to tasks of a complex schedule is a stochastic model. In one or more embodiments, the stochastic disruption model employed by the delay forecasting component 106 models the uncertainty (or the random variation in the one or more inputs over time) associated with predicting the likelihood of potential delays to scheduled tasks of a complex schedule for a system using a low dimensional representation of the state space. In this regard, the state space can reflect the states of the nodes or points where a scheduled task starts or ends, or states of some resources used by those tasks, wherein the number of such resources is less than the number of tasks, and not the tasks themselves. For example, with respect to an airline system, rather than modeling the uncertainty associated with the aircrafts performing the scheduled tasks (e.g., the flights), the state space can correspond to the states of the airport where scheduled flights arrive and depart. In an intentional simplification, for one aircraft's departure, one may restrict oneself to the consideration of the states of the departure airport.

With respect to a system (e.g., an airline system) and its associated complex schedule that is modeled using the subject stochastic disruption models, the random variation or uncertainty in the input is based on the root-cause delays. In this regard, the subject stochastic disruption models assume the root-cause delays are dependent on hidden states of the system, and that the hidden states change over time. For example, in association with an airline system, if the snow starts to fall at a particular airport, this can be modeled as a change to the state of the system (e.g., the airport), and with the changed state comes a different distribution of the root-cause delays. The hidden states of the system are referred to herein as delay states. The delay states and associated probability distribution of root-cause delays of the system are predicted or learned based on machine learning analysis of the historical schedule and historical delay data for the system. As an airline example of a delay state, suppose that many airlines are experiencing departure delays from Boston on a winter morning. Given the number of departure delays and comparable historical delay data, the disclosed technique can characterize the delay state of the Boston airport as being based on bad weather which has been historically shown to effect departures for the next several hours and introduce root-cause delays, which are hour-long in expectation with standard deviation of one hour, when the root-cause delay is assumed to be normally distributed random variable. Thus, in various embodiments, the subject stochastic disruption models can be trained to identify patterns indicating these types of time-dependent sources of delay from data, and characterize the magnitude of delays experienced in each state together with the usual duration of time spent in each state. In this regard, the distribution models can comprise a stochastic model that has been trained using machine learning analysis of historical schedule and historical delay data for a system, to predict probabilities of root-delays, and probabilities of their impact on subsequent tasks.

In some embodiments, delay states or the probability distribution of the root-cause delays can be modeled using one or more hidden Markov models (HMMs). In this regard, the delays within the complex schedule being modeled can be seen as a Markov process. A HMM is a statistical model, which assumes the system is a Markov process with unobserved or hidden states X, samples y of noisy observations Y, which are a random variable, state transition probabilities ρ, and output probabilities r. Training of an HMM model involves, given a history of y, estimating the most likely state transition probabilities ρ and output probabilities r. Application of the HMM model involves considering the state transition probabilities ρ and output probabilities r learned previously, using a history of observations y, to estimate the next state and observation. Once a HMM is trained it becomes just a Markov model.

In one or more embodiments, in association with predicting the probabilities of delays to tasks included in a complex schedule, the delay forecasting component 106 can employ a stochastic disruption model (e.g., included in the stochastic model data 120) for the respective tasks that is a stochastic model having the properties and assumptions described above. For example, the stochastic model can model the tasks and the resources affecting the tasks. The complex schedule can be defined and provided in the planned schedule data 118. For example, the planned schedule data 118 can describe the respective tasks, their scheduled start and end times, and their dependencies on each other and on system resources. The stochastic model can determine the conditional probability distributions of the potential disruptions, given previous disruptions or a state of the system related to the previous disruptions. In this regard, the conditional aspect of the probability distributions of the potential disruptions is based on the conditional state of the system. The evolution of the state of the system is directed by the previous disruptions. This conditional uncertainty can be accounted for in the stochastic disruption model via noise terms representative of the random variation associated with predicting future delays. These noise terms can be learned based on machine learning analysis of historical schedule information and historical delay information for the complex schedule.

In particular, the stochastic disruption model can comprise a delay component that corresponds to delay attributed to one or more root-causes and delay attributed to one or more reactionary delays. In this regard, the stochastic model can comprise a reactionary delay component and a root-cause delay component; the reactionary delay component being a function of previous task end times and the root cause delay component being an independent random process specific to a resource utilised at a specific time. The stochastic model can model the probability distributions of the start times delays to the task as a function of the scheduled start time, plus reactionary delay and start time noise (e.g., a noise term). The start time noise can correspond to a delay state of the system that is specific to the node or location where the task starts. In this regard, the start time noise is dependent on a root-cause delay associated with the start time location. The stochastic model can further model the probability distributions of the end time delays to the task as a function of the actual start time, plus the scheduled duration and end time noise (e.g., another noise term). The end time noise can correspond to a delay state of the system that is specific to the node or location where the task starts. In this regard, the end time noise is dependent on another root-cause delay associated with the end time location. The start time noise term and the end time noise term can be determined or modeled and learned from the historical scheduled data and the historical delay data using one or more HHMs. In a formal notation not considering the mitigating actions for simplicity, a stochastic disruption model for a task i of a complex schedule including a plurality of interdependent tasks can be represented as follows:

$${D}_{i} = {s}_{i} + f ( {s}_{i} - {max}_{j ∈ {ℛ}_{i}} \{ {A}_{j} \} ) + {Y}_{{α}_{i} , {s}_{i}} \\ {A}_{i} = {D}_{i} + {τ}_{i} + {V}_{i} \qquad Equation 1$$

wherein:
Dᵢ is the predicted departure/start time
sᵢ is the scheduled departure/start time
{Aⱼ} is the actual arrival/end time of predecessor task(s) to task i (e.g., the real-time delay data)
[symbol] ᵢ is the movement of predecessors to task i
αᵢ is the departure/start location of task i
Y_{αi}, sᵢ is the departure/start noise term for task i
Aᵢ is the predicted arrival/end time
Tᵢ is the scheduled duration for task i
Vᵢ is the arrival/end noise term for task i

The stochastic disruption model represented by Equation 1 can be applied to each task (or in some implementation one or more tasks) of a complex schedule to determine probability distributions of delay times added to the start times and end times of each task. The noise terms Y and V of Equation 1 can respectively represent the root-cause delay component. In this regard, the noise terms Y and V for the different tasks can respectively vary based on the resources associated with the respective tasks, and the hidden or delay states of the start and end nodes at scheduled start and end times of the respective tasks. Assuming the root-cause delays exhibit some time correlation, the Y term and the V term can be determined for the respective tasks based on machine learning analysis of historical scheduled and historical delay data using one or more HHMs. Complex dependencies across tasks are decomposed into the effect of the delay on shared resources (e.g., the f term) and the root-cause delay factors affecting a resource at a given time (e.g., the Y term). These complex dependencies can be analyzed separately and modeled from the historical schedule and historical delay data using one or more HHMs. For example, in one or more embodiments, multiple resources associated with a task can be modeled using multiple HMMs. The current delay information 104 can identify the actual end times of completed tasks. In one or more embodiments, the delay forecasting component 106 can determine {Aⱼ}, (e.g., the actual end/arrival times of predecessor tasks), based on the defined schedule information (included in the planned schedule data 118) describing scheduled start times and end timed of tasks and dependencies of the tasks on one another. The function:

$$f ( {s}_{i} - {max}_{j ∈ {ℛ}_{i}} \{ {A}_{j} \} ) ,$$

corresponds to the reactionary delay component.

For example, in association with application of the stochastic disruption model represented by Equation 1 as applied to an airline system, a complex schedule for the airline system defined in the planned schedule data 118 can identify a plurality of flights with planned departure and arrival times. At least some of the flights departure times are based on the arrival times of other flights. In this regard, at least some of the departure times of flights are dependent on completion of predecessor flights. The hidden states or delay states of the system correspond to the hidden states or delay states of the one or more airports from which the flights depart and arrive. These hidden states or delay states can be inferred based on patterns in the historical schedule and historical delay data (previously learned). In this embodiment, the stochastic disruption model (e.g., a stochastic model) for a flight of the respective flights can model the probabilities of delay states the one or more airports are in and the probabilities of delays to the task as a function of delays of predecessor flights (e.g., the reactionary delay component) and the delay states of the one or more airports (e.g., the root-cause delay component). For example, if several consecutive flights are delayed in departing an airport, it might be inferred that this airport is in a state of high passenger volume or a state related to bad weather; based on historical data, how long this state will persist can be estimated; and based on this state estimate, the probabilities of future schedule disruptions and their reactionary impacts can be estimated.

In various embodiments, the risk analysis component 108 provides for employing a stochastic disruption model developed for a complex schedule and current delay information 104 to infer losses associated with future disruptions. With these embodiments, based on time delays added to one or more tasks of a complex schedule determined by the delay forecasting component 106 using the techniques described above, the risk analysis component 108 can further determine the loss information 110 regarding losses associated with the time delays. The type of losses can vary based on the type of system and complex schedule that is evaluated using the disclosed techniques. For example, in some implementations, the losses can include financial losses attributed to delays. In other implementations involving losses that impact a consumer system, the losses can include service losses, losses attributed to reduced customer satisfaction and loyalty, losses attributed to negative social media publicity, losses attributed to injury, and the like. In some implementations in which the system involves a complex scheduled directed to development of a work product, the losses attributed to some delayed tasks in the process can result in an incomplete work product, a faulty work product, and the like. In another example implementation in which the system comprises a computer networking system that facilitates wired and wireless connectivity to the Internet and/or a cellular network in association with delivery of various types of traffic, the losses attributed to certain delays can include loss in bandwidth or throughput, loss in connectivity quality, loss in connectivity entirely, lost data packets, and the like.

In some embodiments, the risk analysis component 108 can determine the losses attributed to delays to tasks of a complex schedule using defined loss information developed for the complex schedule and associated system. This loss information can be provided in the loss/risk data 122 and employed by the risk analysis component 108. For example, in some implementation, the loss information associated with a complex scheduled and system can include a defined loss model that determines losses as a function of the start time and/or end time of a task. For instance, with respect to a loss model that attributes financial costs as a function of the start time and/or end time of a task, the risk analysis component 108 can determine an amount of financial loss (if any) attributed to a delayed task based on the start time of the task and the end time of the task using the loss model. For example, with respect to an airline system that involves a complex schedule of flights to and from one or more airports over the course of a defined period of time, using a cost model for the system and information determined by the delay forecasting component 106 indicating an expected delay to a departure time of a flight being 30 minutes and expected delay to an arrival time of the flight being 40 minutes, the risk analysis component 108 can determine an expected amount of financial loss attributed to the departure delay, the arrival delay, and/or an expected amount of financial loss attributed to both the departure delay and the arrival delay.

According to these embodiments, the risk analysis component 108 can determine and generate loss information 110 that identifies delays to one or more tasks of a complex schedule and further identifies losses attributed to the losses. For example, the risk analysis component 108 can generate loss information that identifies an amount of delay added to start time of a task and the loss attributed to that delay. According to this example, the loss information 110 can identify a loss value of 20k attributed to a delay of 10 minutes. Further, because the delay forecasting component 106 can determine a probability distribution of delays, the risk analysis component 108 can further determine a probability distribution of losses. In this regard, based on the probability associated with a delay, the risk analysis component 108 can determine a corresponding probability associated with a loss attributed to the delay. For example, the loss information 110 can include information that indicates a 15% probability of a $20k loss based on a 15% probability that a certain task will delayed 20 minutes (wherein a delay of 20 minutes is attributed to a $20k loss).

In addition to determining losses associated with one or more delays to tasks of a complex schedule, the risk analysis component 108 can also determine or infer one or more mitigating actions that reduce or eliminate the losses. For example, with respect to an aircraft schedule, the disclosed systems can determine a combination of flight cancelations and/or flight speed increases (at the cost of burning extra fuel, wear and tear on the aircraft, etc.) that minimize costs that would be attributed to not performing any mitigating action. With these embodiments, information regarding the possible mitigating actions that could be implemented for a particular system to minimize expected losses attributed to potential delays can be pre-defined and stored as mitigating actions data 124. For example, in some embodiments, the defined mitigating actions can include cancellation of a task, adaptation to a rate of effort applied to the task, adaptation to a resource used for the task, addition of one or more resources used for the task, and the like. For instance, with respect to the airline industry, the defined mitigating actions can include but are not limited to, cancelation of a flight, increasing the speed of one or more flights, decreasing the speed of one or more flights, employing a different resource in association with one of the flights (e.g., a different aircraft, a different crew member, a differ departure or arrival gate, etc.), and the like.

In this regard, in one or more embodiments, in association with determining the probability distributions of the time delays, the delay forecasting component 106 can further employ the stochastic disruption model developed for a complex schedule, and based on the defined scheduled information (provided in the planned schedule data 118 identifying the planned start/end times of the tasks, dependencies between the tasks and the like), and the current delay information 104, determine how the time delays are affected based on potential implementation of one or more defined mitigating actions directed to reduce or eliminate the time delays. In particular, the delay forecasting component 106 can employ the stochastic disruption model represented by Equation 1 and further adapt the stochastic disruption model to consider how implementation of one or more defined mitigating actions that are known to reduce or eliminate the delay component of the stochastic disruption model, effect the probability distribution of the delay times added to the respective tasks of the complex schedule. As discussed above, the delay component of the stochastic disruption model comprises both a reactionary delay component and a root-cause delay component. In some embodiments, the defined mitigating actions can include one or more known actions that amount to cancelation of the reactionary delay component of the stochastic disruption model. The defined mitigating actions can also include one or more actions that are known to recoup some of the delay due to both the reactionary delay component and the root cause delay component.

For example, Equation 2 below presents another example stochastic disruption model that is an adaptation of Equation 1 which can be used by the delay forecasting component 106 to further determine a probability distribution of the delay to the start/depart times of a task (e.g., Di the parameter) and the probability distribution of the delay to the end/arrival times of the task (e.g., Ai parameter) as a function of one or more mitigations actions in addition the current delay information 104 affecting the task and the planned schedule information for the complex schedule.

$${D}_{i} = {s}_{i} + {s}_{i}^{′} + {u}_{i} f ( {s}_{i} - {max}_{j ∈ {ℛ}_{i}} \{ {A}_{j} \} ) + {Y}_{{α}_{i} , {s}_{i}} \\ {A}_{i} = {D}_{i} + {τ}_{i} + {V}_{i} \qquad Equation 2$$

wherein:
Dᵢ is the predicted departure/start time
sᵢ is the scheduled departure/start time
s′ᵢ is a first mitigation action (e.g., increase task speed)
uᵢ is a second mitigation action (e.g., cancelation of task)
{Aⱼ} is the actual arrival/end time of predecessor task(s) to task i (e.g., the real-time delay data)
[symbol] ᵢ is the movement of predecessors to task i
αᵢ is the departure/start location of task i
Y_{αi}, sᵢ is the departure/start noise term for task i
Aᵢ is the predicted arrival/end time
Tᵢ is the scheduled duration for task i
Vᵢ is the arrival/end noise term for task i

As shown in Equation 2, two potential mitigating parameters are integrated into the delay forecasting model of Equation 1, respectively represented by parameters s′ᵢ and uᵢ. In the embodiment shown, the uᵢ ∈{0,1} models the cancelations (or subcontracting, use of stand-by aircraft, or a similar actions) to get rid of the reactionary component of the delay. For example, in some implementations, any mitigating action that eliminates the reactionary delay component can be effectively reduced to a cancelation of the original task, albeit at varying costs, (e.g., the use of a spare aircraft can be modeled as a cancelation of the original flight, and the use of the spare aircraft at a cost lesser than that of rebooking and compensating passengers). The s′ᵢ ∈[−sᵢ,0] models the speed-up (e.g., at a cost of increased fuel usage) to recoup some of the delay due to both reactionary and root causes.

Similar to Equation 1, with Equation 2, complex dependencies across tasks are decomposed into the effect of the delay on shared resources (e.g., the f term) and the root-cause delay factors affecting a resource at a given time (e.g., the Y term). These complex dependencies can be analyzed separately and modeled from the historical schedule and historical delay data using one or more HHMs. Having accounted for the time-dependent nature of the residuals using HMMs, the delay forecasting component 106 can further use the Markov decision processes in the control of parameters s′ᵢ and uᵢ wherein time is readily discretized. Accordingly, in addition to determining a distributional probability of the start time delays and the end time delays of a task, the delay forecasting component 106 can further determine the effects of implementation of one or more defined mitigating actions on the distributional probability of the start time delays and the end time delays of a task. For example, the delay forecasting component 106 can determine the probability distribution of start times and/or end times with and without mitigating actions, with different mitigating actions, with a single mitigating action, and with different combinations of mitigating actions.

The risk analysis component 108 can also determine costs associated with implementation of the one or more defined mitigating actions using a cost model that further accounts for implementation of the mitigating actions. In accordance with these embodiments, the loss/risk data 122 can also include loss mitigation information that associates defined mitigation costs attributed to implementation of the one or more defined mitigating actions and the loss model employed by the risk analysis component 108 to determine losses attributed to delays can further account for mitigation costs attributed to implementation of one or more mitigating actions. For example, the loss model for a complex schedule and associated system can determine loss information as a function of loss attributed to arrival delay, loss attributed to departure delay, and loss attributed to implementation of one or more mitigating actions (e.g., costs of canceling a flight, cost of using a standby aircraft, cost of burning more fuel to increase speed, etc.).

Further, based on the costs associated with the respective time delays and the costs associated with implementation of the one or more mitigating actions, the risk analysis component 108 can determine a subset of the one or more defined mitigating actions or combinations of the one or more defined mitigating actions that minimizes the expected losses or some other risk measure of the losses. This can include one or more mitigating actions associated with a single task as well as one or more mitigating actions associated with downstream tasks. For example, in one implementation, based on the loss associated with the delay associated with a particular task, the risk analysis component can determine which (if any) of the one or more defined mitigating actions or combination of the mitigating actions reduces the expected loss. The risk analysis component 108 can further determine the degree to which one or more of the mitigating actions and/or combinations of the one or more mitigating actions reduces the expected loss (e.g., the expectation of the amount, by which we reduce the amount). The risk analysis component 108 can further identify a subset of the mitigating actions (or combinations of the mitigating actions), that reduces the loss.

Further, in some embodiments, the risk analysis component 108 can consider the probability distribution of the losses (which are correlated to the probability distribution of the delays), to determine one or more mitigating actions and/or combinations of the mitigating actions (e.g., cancellations and speed-ups) that minimize a risk measure of the total loss (such as the expectation, value at risk, expected shortfall or CVaR, etc.). With these embodiments, the risk analysis component 108 can perform a cost/risk analysis that involves evaluating both the risk measure of the loss reduced based on implementation of one or more defined mitigating actions and/or combinations of the mitigating actions and the risk measure of the loss. For example, although a certain combination of mitigating actions may reduce the loss of $100k occurring with 5% probability to $10k, if the mitigating actions where implemented at a cost of $10k and had no other benefits, the added cost of the mitigating actions (at $10k) would not be worthwhile (e.g., with probability of 95%, they would be wasted. The expected loss of S5k would not be offset by the costs of $10k, and the mitigating actions could result in potential new delay and associated loss (e.g., not represented in the stochastic disruption model), which assumes the mitigating actions are always possible to execute flawlessly. Thus, in some embodiments, the risk analysis component can determine risk measures for the one or more mitigating actions that reduce expected loss that reflects the degree to which the one or more mitigating actions reduces expected loss, which in turn depends on the probability that the particular loss will be incurred.

Accordingly, in some embodiments, the loss information 110 determined by the risk analysis component can also identify losses associated with implementation of one or more mitigating actions, one or more mitigating actions that reduce or eliminate the expected losses, and the amount of reduction of the expected losses afforded by implementation of the one or more mitigating actions, and other risk measures determined for the one or more mitigating actions.

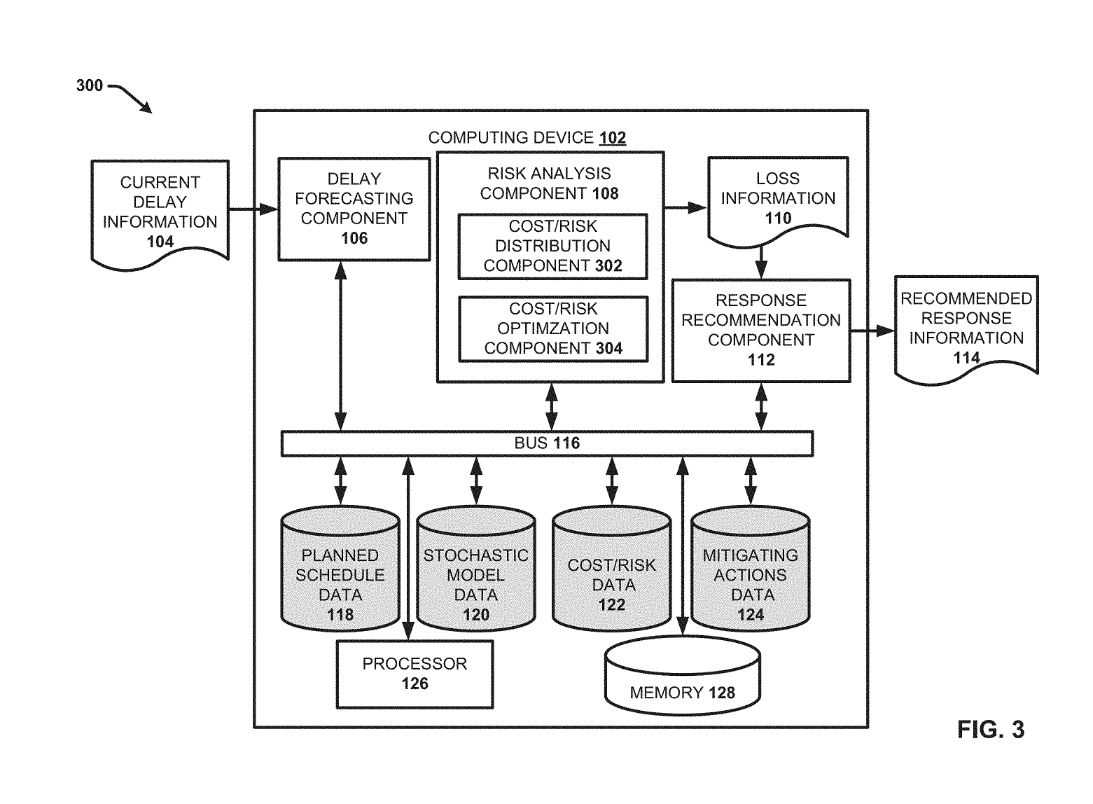

It can be appreciated that delays to certain tasks can propagate throughout remaining or downstream tasks of a complex schedule, resulting in compounded losses. For example, in furtherance to the airline schedule, a departure delay of a first leg, can result in a departure delay of a second leg, third leg, etc. and each of these delays may be associated with additional losses. Accordingly, in various embodiments, the loss model developed and employed for a system and associated complex schedule can be configured to account for losses attributed to propagated delays to downstream tasks. Additional detailed information regarding some example loss models that can be employed by the risk analysis component 108 to determined losses attributed to delays of a complex schedule and information regarding one or more mitigating actions that reduce or eliminate the expected losses are described infra with reference to FIGS. 3-5.

In some implementations, the loss information 110 can be rendered at the computing device and/or sent to another entity for evaluation in real-time. In this regard, the loss information 110 can be rendered at the computing device 102 and/or sent to another entity for evaluation. In this regard, the loss information 110 can but is not limited to: expected losses attributed to expected start time and/or end time delays of one or more tasks, the probability distribution of the losses attributed to the start time and/or end time delays, expected losses associated with implementation of one or more mitigating actions, one or more mitigating actions that reduce or eliminate the expected losses, and the amount of reduction of the expected losses afforded by implementation of the one or more mitigating action.

In other implementations, the response recommendation component 112 can evaluate the loss information 110 to determine or infer a recommendation regarding implementation of the one or more defined mitigating actions. The response recommendation component 112 can further render the recommendation at the computing device 102 and/or provide the recommendation to another entity (e.g., system, device, etc.) for evaluation or implementation. In the embodiment shown, the recommended response is represented by recommended response information 114. For example, the response recommendation component 112 can determine whether to recommend implementation of a defined mitigating actions or combination of mitigating actions based on a degree to which it minimizes the expected losses. For instance, in some embodiments, the response recommendation component 112 can recommend implementation of one of the mitigating actions or combination of the mitigating actions that reduces the most expected loss. In another embodiment, the response recommendation component can employ a threshold loss reduction threshold wherein the response recommendation component 112 recommends implementation of one or more mitigating actions if the one or more mitigating actions reduce expected losses by more than a minimum loss reduction threshold. In other embodiments, the response recommendation component 112 can consider the probability distribution of the time delays and the corresponding probability distribution of costs to be incurred when determining whether to recommend a mitigating action or combination of mitigating actions for implementation. In the regard, the response recommendation component 112 can further recommend a mitigating action or mitigating action combination based on its associated risk measure. For example, the response recommendation component 112 can recommend a mitigating action or mitigating action combination based on the average losses associated with a certain proportion of the worst outcomes.

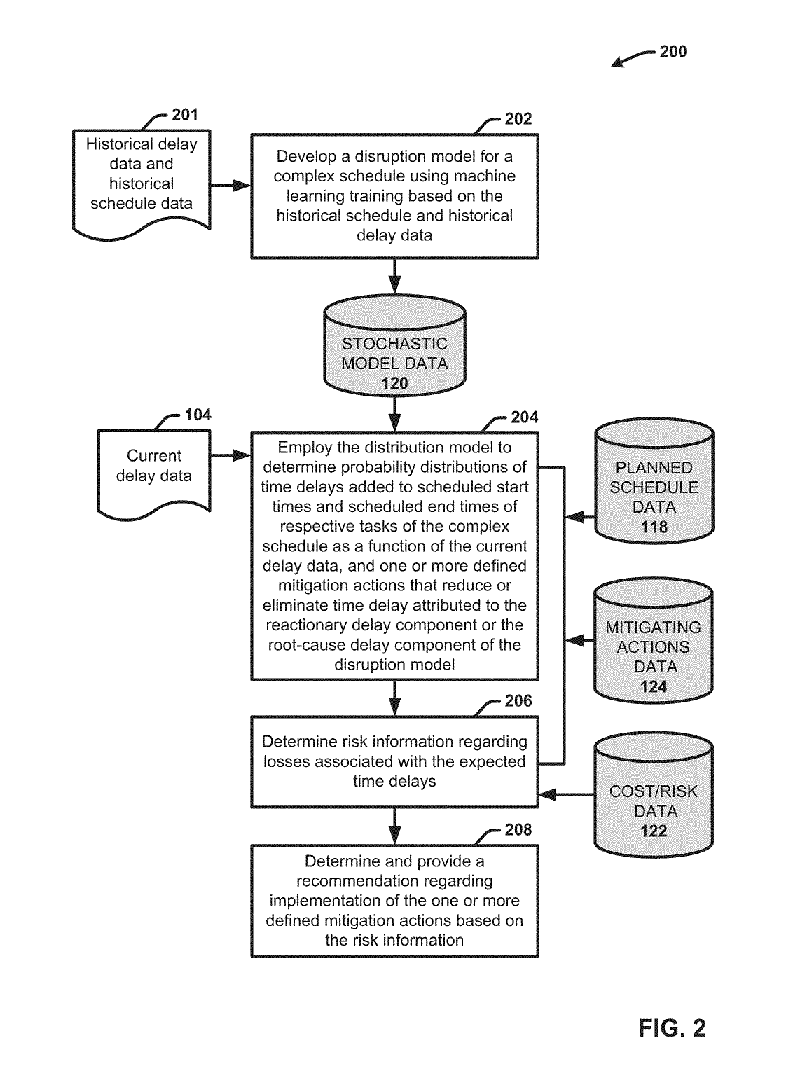

FIG. 2 presents a high-level flow diagram of an example, non-limiting computer-implemented process 200 for controlling potential disruptions to complex schedules in real-time based on a probability distribution of the potential disruptions in accordance with one or more embodiments of the disclosed subject matter. In one or more embodiments, process 200 can be performed by the computing device 102 of system 100 (and additional systems described herein) using the delay forecasting component 106, the risk analysis component 108, and the response recommendation component 112. Repetitive description of like elements employed in respective embodiments is omitted for sake of brevity.

At 202, a system comprising a processor (e.g., system 100), can develop a stochastic disruption model for a complex schedule using machine learning training based on the historical schedule and historical delay data 201 for the complex schedule. For example, the stochastic disruption model can be a stochastic model that can determine a probability distribution of start and end times of tasks of the complex schedule based on current delay information 104, planned schedule information regarding planned start times and durations of the task and dependencies of the tasks relative to one another and on resources used to perform the tasks, and inferred probability distributions of root-cause delays affecting the resources at the start and end points of the tasks. In one or more embodiments, the inferred probability distributions of the root-cause delays and the manner in which they impact the start times and end times of the tasks can be learned based on the historical delay data 201 using one or more HHMs.

At 204, the system can employ the distribution model to determine the probability distributions of time delays added to scheduled start times and scheduled end times of respective tasks of the complex schedule as a function of the current delay data, and one or more defined mitigating actions that reduce or eliminate time delay attributed to the reactionary delay component or the root-cause delay component of the stochastic disruption model. For example, the delay forecasting component 106 can employ Equation 1 to determine the distributions of start times and end times without implementation of any mitigating actions and Equation 2 to determine adjusted distributions of start times and end times with implementation of one or more mitigating actions. At 206, the system can determine loss information regarding losses associated with the time delays. For example, the risk analysis component 108 can determine loss information included expected losses attributed to the expected time delays without performance of the any mitigating actions and with performance of one or more mitigating actions. At 208, the system can determine and provide a recommendation regarding implementation of the one or more defined mitigating actions based on the loss information. For example, the response recommendation component 112 can recommend mitigating actions for implementation that minimize the expected losses.

FIG. 3 illustrates a block diagram of another example, non-limiting system 300 that facilitates proactively controlling potential disruptions to a complex schedule in real-time based on a probability distribution of the potential disruptions in accordance with one or more embodiments of the disclosed subject matter. Repetitive description of like elements employed in respective embodiments is omitted for sake of brevity.

In the embodiment shown, the risk analysis component 108 can include the cost/risk distribution component 302 and loss/risk optimization component 304. As discussed above, in some embodiments, the risk analysis component 108 can determine loss information 110 that reflects losses attributed to delays using a defined cost model for the complex schedule. In one or more embodiments, the defined cost model can be configured to determine the losses based at least in part on costs attributed to start time delays (e.g., delays to the start times of the respective tasks) and costs attributed to end time delays (e.g., delays to the end times of the respective tasks). The cost model can account for complex decencies between tasks and resources employed for the respective tasks. In this regard, the cost model can evaluate the costs associated with a start time delay and/or an end time delay considering the propagation of the delay to downstream tasks.

In one or more embodiments, the cost/risk distribution component 302 can determine these costs attributed to the start time delays using Equation 1 and considering the propagation of the delays to downstream tasks, (and without considering the impact of implementation of one or more mitigating actions), using a dynamical programming function or an approximate dynamical programming function. Dynamic programming is a method to solve optimal control problems. Wither respect to both the dynamical programming function and the approximate dynamical programming function, the evaluation can involve deriving the cost-to-go function for all tasks, starting with the final task and then going backwards until the initial task is reached.

To clarify the meaning of the cost-to-go and value function, consider the classical finite-horizon stochastic control problem displayed in Equation 3:

$$W ( x , t ) := {inf}_{u ( \cdot ) , u ( t ) ∈ U} E ( {\int }_{0}^{t} 𝓁 ( y ( t ; x ) , u ( t ) ) dt ) \\ dy ( t ) = F ( y ( t ) , u ( t ) ) dt + \sqrt{2 ɛ} dW ( t ) \\ y ( 0 ) = x \qquad Equation 3$$

wherein W denotes the value function, y denotes the state of the Markov diffusion process, t denotes the time, l denotes the cost function, (e.g., the cost of the delay and/or the mitigation costs), u denotes the control action (e.g., canceling a task, speeding up/down a task, etc.) chosen out of a set of admissible control actions U, E stands for the expectation, x is the initial condition for the process y, epsilon defines the variance of the noise given by the Wiener process W. Under standard assumptions, the value function W solves the non-linear parabolic equation, a standard object of dynamical programming, displayed in Equation 4:

$${\partial }_{t} W + {sup}_{u ∈ U} \{ - F ( x , a ) \cdot ∇ W - 𝓁 ( x , u ) \} = ɛΔ W \qquad Equation 4$$

Equation 4 is a regularized version of the standard HJB equation corresponding to the deterministic optimal control problems. In this regard, solution W has square-integrable gradients. The latter allows implementation of the optimal control in the feedback form by using the gradient of the value function W. In accordance with one or more embodiments, Equation 4 can be discretized with the running cost defined by l, which reflects the sum of the delay cost and mitigation costs, and the function F can be defined as in Equation 2.

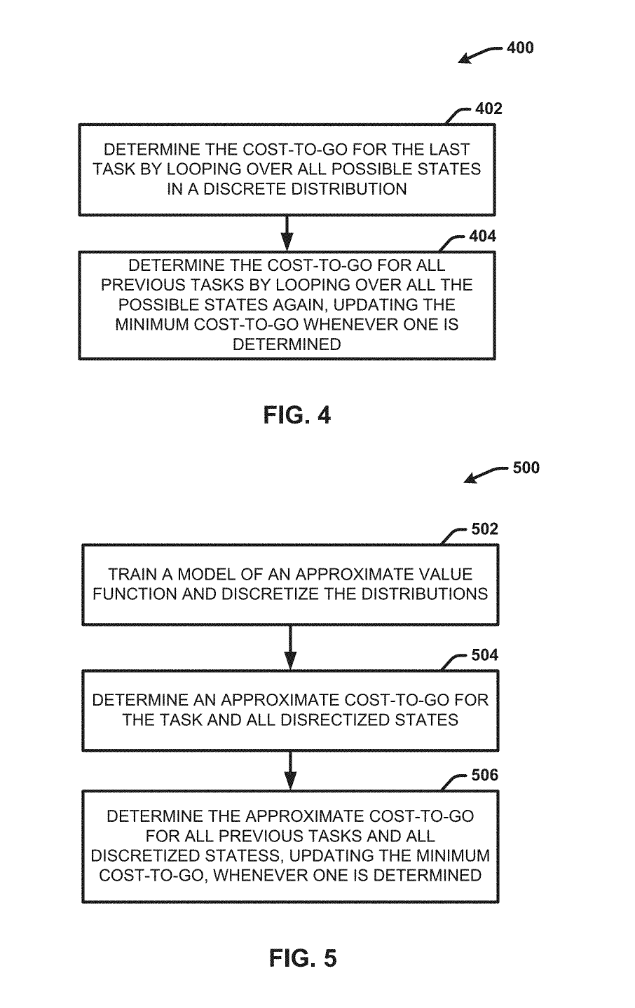

For example, FIG. 4 provides a high-level flow diagram of an example dynamical programming process 400 that can be employed by the cost/risk distribution component 302 to determine costs attributed to start time delays to tasks of a complex schedule, wherein the start time delays include a probability distribution of start time delays for each (or in some implementations, one or more) of the scheduled states. At 402, the cost/risk distribution component 302 can determine the cost-to-go for the last task by looping over all possible states in a discrete distribution. Then at 404, the cost/risk distribution component 302 can iterate back from the last task to all previous tasks (that have not occurred yet or are currently occurring) looping over all possible states again, and then updating the minimum cost-to-go whenever one in determined.

For example, FIG. 5 provides a high-level flow diagram of an example approximate dynamical programming process 500 that can be employed by the cost/risk distribution component 302 to determine costs attributed to start time delays to tasks of a complex schedule, wherein the start time delays include a probability distribution of start time delays for each (or in some implementations, one or more) of the scheduled start times. At 502 the cost/risk distribution component 302 can train a model of an approximate value function and discretize the distributions. At 504, the cost/risk distribution component 302 can determine an approximate cost-to-go for the task and all discretized states. Then at 506, the cost/risk distribution component 302 can determine the approximate cost-to-go for all previous tasks and all tasks and all discretized states, updating the minimum cost-to-go, whenever one is determined.

With reference back to FIG. 3, the loss/risk optimization component 304 can further evaluate the impact implementation of one or more mitigating actions (including combinations of the one or more mitigating actions) have on the expected losses using Equation 2 and considering the propagation of the delays and the mitigating actions to downstream tasks, using a dynamical programming function or an approximate dynamical programming function. In this regard, by evaluating Equation 2 using a dynamical programming function or an approximate dynamical programming function, the loss/risk optimization component 304 can determine subsets of the mitigating actions (including combinations of the mitigating actions) that minimize the expected losses, thereby facilitating determine and selecting the optimal mitigating actions (or mitigating actions combinations) to implement to reduce the expected losses.

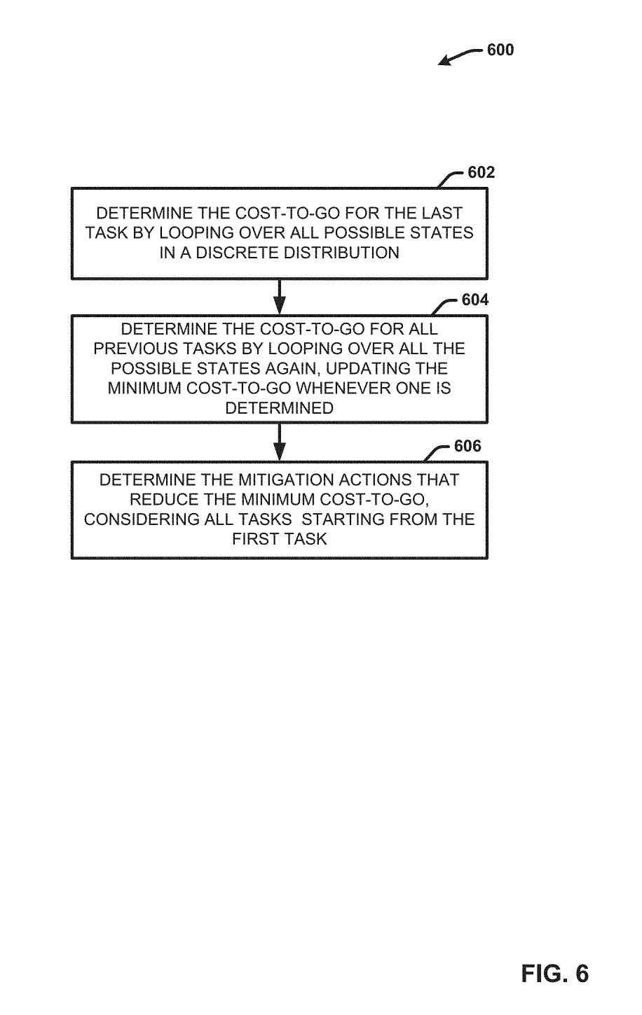

For example, FIG. 6 provides a high-level flow diagram of an example dynamical programming process 600 that can be employed by the loss/risk optimization component 304 to determine one or more mitigating actions that minimize expected costs attributed to start time delays to tasks of a complex schedule, wherein the start time delays include a probability distribution of start time delays for each (or in some implementations, one or more) of the scheduled start times. At 602, the loss/risk optimization component 304 can determine the cost-to-go for the last task by looping over all possible states in a discrete distribution. Then at 604, the loss/risk optimization component 304 can iterate back from the last task to all previous tasks (that have not occurred yet or are currently occurring) looping over all possible states again, and then updating the minimum cost-to-go whenever one in determined. Further at 606, the loss/risk optimization component 304 can determine the mitigating actions that reduce the minimum cost-to-go, considering all tasks starting from the first tasks. The reduced minimum cost-to-go reflects the costs of the mitigating actions. In this regard, with respect to application of the subject process to in real-time to a system that is currently executing a process according to the complex schedule, the first task can correspond to the current task being executed at the current point in time or the task directly following the current task.

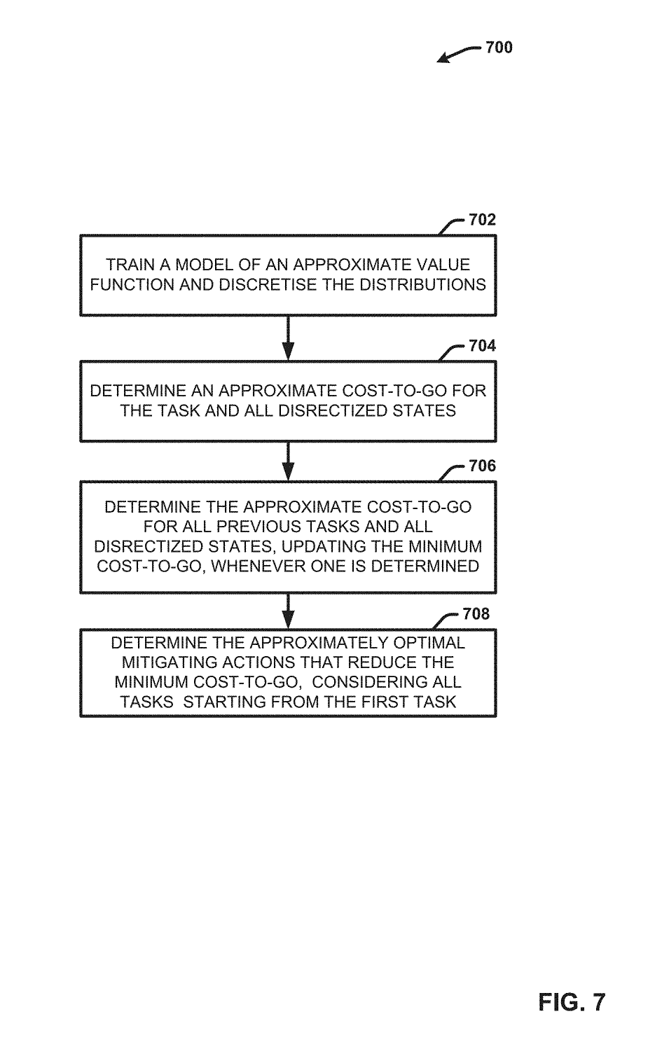

For example, FIG. 7 provides a high-level flow diagram of another example approximate dynamical programming process 700 that can be employed by the loss/risk optimization component 304 to determine one or more mitigating actions that minimize expected costs attributed to start time delays to tasks of a complex schedule, wherein the start time delays include a probability distribution of start time delays for each (or in some implementations, one or more) of the scheduled start times. At 702 the loss/risk optimization component 304 can train a model of an approximate value function and discretize the distributions. At 704, the loss/risk optimization component 304 can determine an approximate cost-to-go for the task and all discretized states. At 706, the loss/risk optimization component 304 can determine the approximate cost-to-go for all previous tasks and all tasks and all discretized states, updating the minimum cost-to-go, whenever one is determined. Further at 708, the loss/risk optimization component 304 can determine the approximately optimal mitigating actions that reduce the minimum cost-to-go, considering all tasks starting from the first tasks. The reduced minimum cost-to-go reflects the costs of the mitigating actions. In this regard, with respect to application of the subject process to in real-time to a system that is currently executing a process according to the complex schedule, the first task can correspond to the current task being executed at the current point in time or the task directly following the current task.

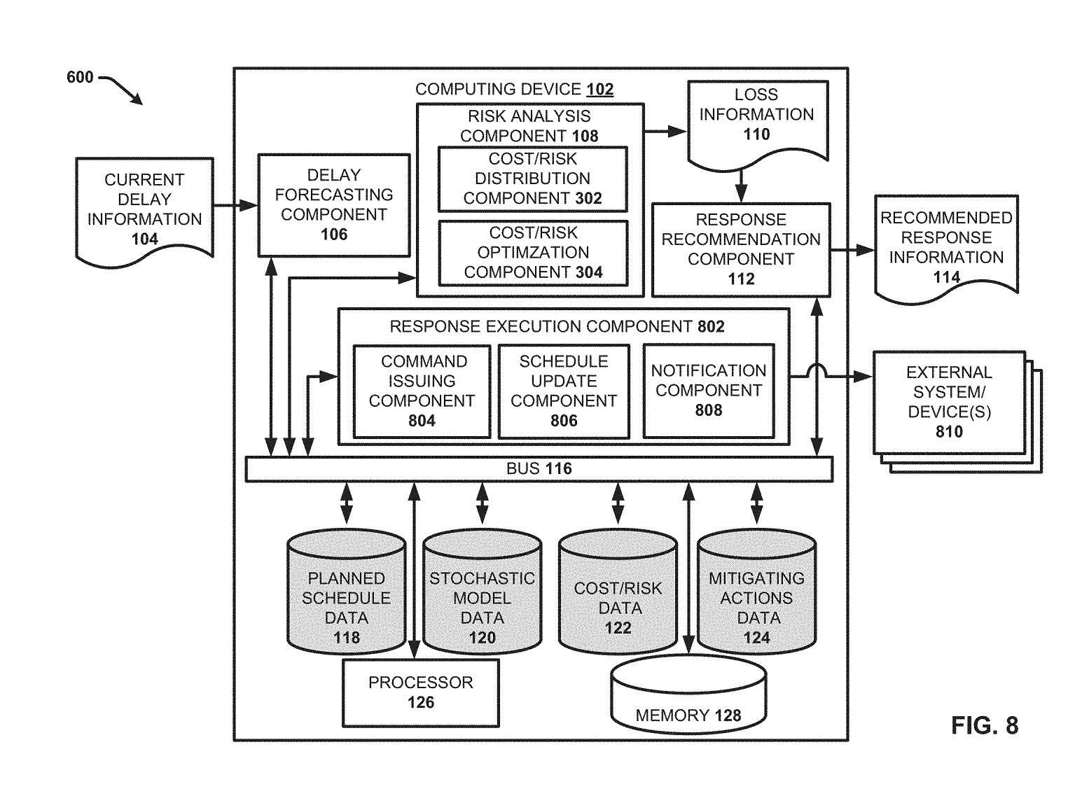

FIG. 8 illustrates a block diagram of another example, non-limiting system that facilitates proactively controlling potential disruptions to a complex schedule in real-time based on a probability distribution of the potential disruptions in accordance with one or more embodiments of the disclosed subject matter description of like elements employed in respective embodiments is omitted for sake of brevity.

In the embodiment shown, the computing device 102 can further include response execution component 802 to facilitate automatically executing one or more selected mitigating actions or responses determined by the response recommendation component 112. In this regard, the response execution component 802 can communicate with one or more external systems and devices 810 to facilitate execution of the one or more selected mitigating actions or responses. For example, in the embodiment shown, the response execution component 802 can include command issuing component 804, schedule update component 806, and notification component 808.

In some implementations in which a mitigating action selected or recommended for implementation by the response recommendation component 112 includes a change to a resource used for a task or the manner in which the resource is used for the task, the command issuing component 804 can send automatically send a command to an external system or devices 810 that directs the external system or source to execute the change. For example, in an implementation in which the change includes an increase or decrease in the speed and corresponding duration at which a task is performed (e.g., increase or decrease flight speed), the command issuing component 804 can send a commend to the entity (associated with the one or more external systems or devices 810) responsible for controlling the speed at which the task is performed directing the entity to change the speed accordingly. In some implementation, the entity can include a machine or device that can execute the command without human intervention. For example, with respect to the airline industry, the entity can include a computing system included in an aircraft that controls the speed of the aircraft in association with an autopilot mode. According to this example, the command issuing component 804 can automatically issue or send a command to the computing system of the aircraft that can cause the computing system to reduce or increase the speed of the aircraft. In another example in which the system involves a package delivery system that employs drones for package delivery, and the mitigating action includes a change to the flight plan of the drone, the command issuing component 804 can send a command to the drone that can cause the drone to automatically change its flight plan accordingly. In another example in association with a computer networking system wherein the mitigating action selected involves changing allocation or utilization of system resources to machines to perform certain tasks, the command issuing component 804 can communicate with the machines to cause them to change allocation of the system resources accordingly.

The schedule update component 806 can communicated with one or more scheduling systems provided at one or more external systems or devices to automatically update scheduling changes to tasks and resources utilized for the respective tasks. For example, implementations in which a mitigating action involves cancelation of a task (e.g., cancelation of a flight), the schedule update component 806 can communicate with a scheduling system to automatically cancel the task and update the schedule to reflect the cancelation in real-time. In another example in which the mitigating action involves changing of a departure or arrival gate of an aircraft, the schedule update component 806 can further update the schedule with the scheduling system to implement the gate change. In another example associated with a package delivery system, the mitigating action can include a change to the specific packages that are scheduled for delivery and/or the specific vehicles (e.g., drones, trucks, etc.) scheduled to deliver the packages. According to this example, the schedule update component 806 can update the delivery schedule accordingly.

The notification component 808 can provide for generating and sending notifications to one or more external systems or devices regarding one or more mitigating actions that are implemented automatically. For example, the notification component 808 can generate and send notifications to various selected systems and devices regarding cancelation of a flight, a change to the resources used for a task (e.g., using a standby aircraft, using an alternative gate, etc.), and the like.

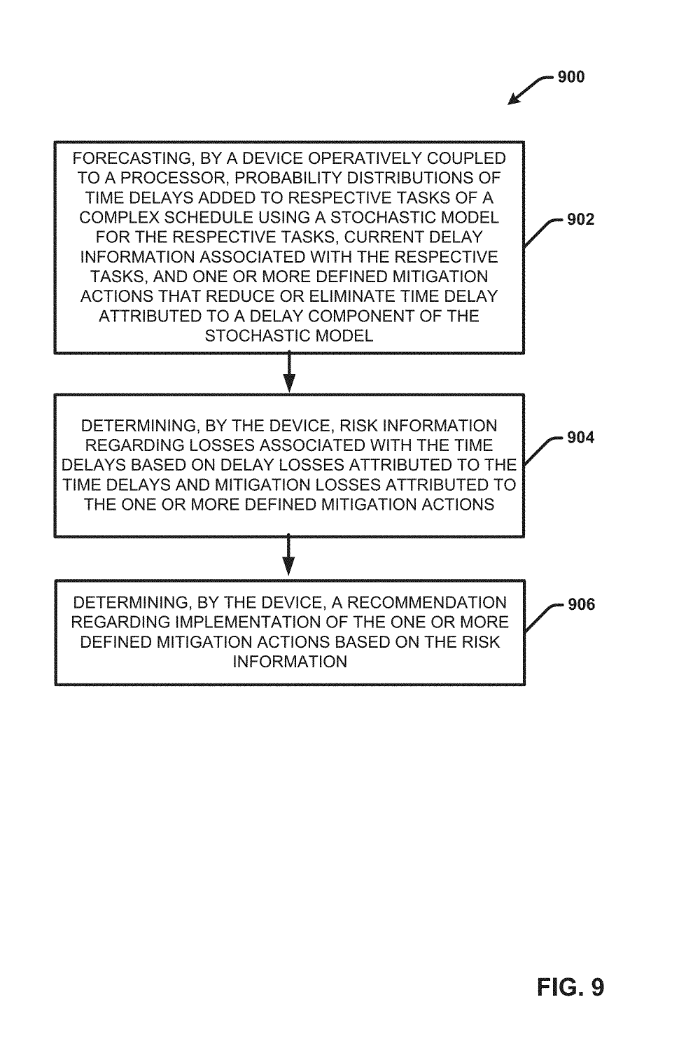

FIG. 9 illustrates an example non-limiting computer-implemented process 900 for proactively controlling potential disruptions to a complex schedule in real-time based on a probability distribution of the potential disruptions in accordance with one or more embodiments of the disclosed subject matter. Repetitive description of like elements employed in respective embodiments is omitted for sake of brevity.

At 902, a device operatively coupled to a processor (e.g., computing device 102), forecasts probability distributions of time delays added to respective tasks of a complex schedule using a stochastic model for the respective tasks, current delay information associated with the respective tasks, and one or more defined mitigating actions that reduce or eliminate time delay attributed to a delay component of the stochastic model (e.g., using the delay forecasting component 106). At 904, the device determines loss information regarding losses associated with the time delays based on delay losses attributed to the time delays and mitigation losses attributed to the one or more defined mitigating actions (e.g., using risk analysis component 108). At 906, the device determines a recommendation regarding implementation of the one or more defined mitigating actions based on the loss information (e.g., using response recommendation component 112).

FIG. 10 illustrates another example non-limiting computer-implemented process 1000 for proactively controlling potential disruptions to a complex schedule in real-time based on a probability distribution of the potential disruptions in accordance with one or more embodiments of the disclosed subject matter. Repetitive description of like elements employed in respective embodiments is omitted for sake of brevity.

At 1002, a device operatively coupled to a processor (e.g., computing device 102), forecasts probability distributions of time delays added to respective tasks of a complex schedule using a stochastic model for the respective tasks, current delay information associated with the respective tasks (e.g., using delay forecasting component 106). At 1004, the device determines costs associated with the delays using a cost model for the complex schedule (e.g., using risk analysis component 108). At 1006, the device determines one or more mitigating actions or combinations of mitigating actions (e.g., which tasks to cancel, which tasks to increase speed, etc.), that reduce the expected costs based in part on how they impact the time delays as determined using the stochastic model (e.g., using risk analysis component 108). For example, the risk analysis component can employ Equation 2, the current delay information 104, the information defining the complex schedule, and the cost model as input and perform a dynamic programming process (e.g., process 600) or an approximate dynamic programming process (e.g., process 600), to determine the mitigating actions that minimize the expected costs. Then at 1008, the device can select a mitigating action or mitigating action combination for implementation based on the mitigating action or the mitigation and combination being determined to reduce the expected costs above a minimum cost reduction threshold (e.g., using response recommendation component 112).

In other implementations, the response recommendation component can select the mitigating action or mitigating action combination that reduces the expected costs the most. Still in yet another implementation, the response recommendation component can select the mitigating action or the mitigating action combination based on a risk measure determined for the mitigating action or mitigating action combination. In this regard, the risk measure can reflect both the amount of the costs reduced, and the probability that the expected or higher costs will be incurred.

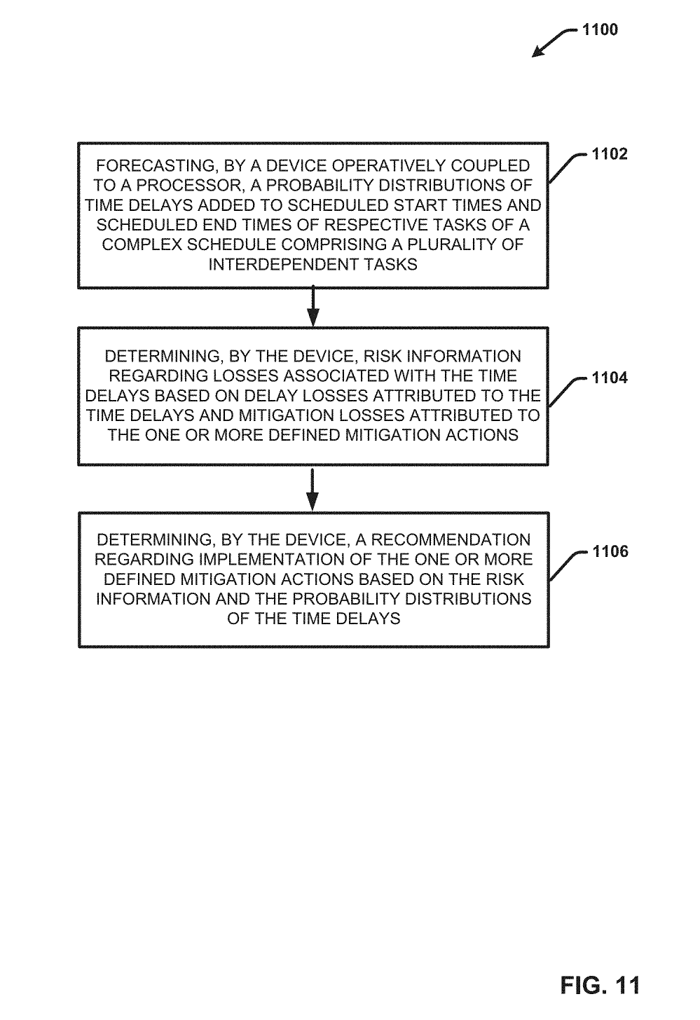

FIG. 11 illustrates another example non-limiting computer-implemented process 1100 for proactively controlling potential disruptions to a complex schedule in real-time based on a probability distribution of the potential disruptions in accordance with one or more embodiments of the disclosed subject matter. Repetitive description of like elements employed in respective embodiments is omitted for sake of brevity.

At 1102, a device operatively coupled to a processor (e.g., computing device 102) forecasts probability distributions of time delays added to scheduled start times and scheduled end times of respective tasks of a complex schedule comprising a plurality of interdependent tasks (e.g., using delay forecasting component 106). At 1104, the device determines loss information regarding losses associated with the time delays based on delay losses attributed to the time delays and mitigation losses attributed to the one or more defined mitigating actions (e.g., using risk analysis component 108). At 1106 the device determines a recommendation regarding implementation of the one or more defined mitigating actions based on the loss information and the probability distributions of the time delays (e.g., using response recommendation component 112).

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

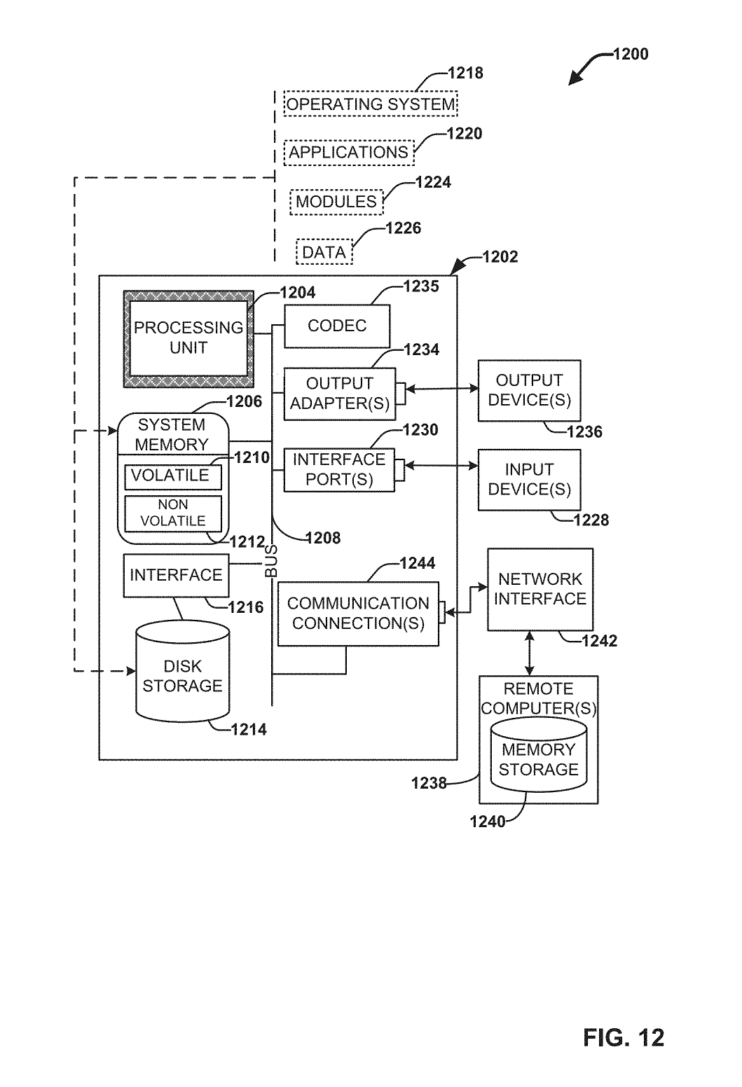

In connection with FIG. 12, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 12, an example environment 1200 for implementing various aspects of the claimed subject matter includes a computer 1202. The computer 1202 includes a processing unit 1204, a system memory 1206, a codec 1235, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13124), and Small Computer Systems Interface (SCSI).

The system memory 1206 includes volatile memory 1210 and non-volatile memory 1212, which can employ one or more of the disclosed memory architectures, in various embodiments. The basic input/output system (BIOS), containing the basic routines to transfer information between elements within the computer 1202, such as during start-up, is stored in non-volatile memory 1212. In addition, according to present innovations, codec 1235 can include at least one of an encoder or decoder, wherein the at least one of an encoder or decoder can consist of hardware, software, or a combination of hardware and software. Although, codec 1235 is depicted as a separate component, codec 1235 can be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1212 can employ one or more of the disclosed memory devices, in at least some embodiments. Moreover, non-volatile memory 1212 can be computer memory (e.g., physically integrated with computer 1202 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1210 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1202 can also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD), flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1214 to the system bus 1208, a removable or non-removable interface is typically used, such as interface 1216. It is appreciated that disk storage 1214 can store information related to an entity. Such information might be stored at or provided to a server or to an application running on an entity device. In one embodiment, the entity can be notified (e.g., by way of output device(s) 1236) of the types of information that are stored to disk storage 1214 or transmitted to the server or application. The entity can be provided the opportunity to opt-in or opt-out of having such information collected or shared with the server or application (e.g., by way of input from input device(s) 1228).

It is to be appreciated that FIG. 12 describes software that acts as an intermediary between entities and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

An entity enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port can be used to provide input to computer 1202 and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a delay forecasting component that forecasts a probability distribution of time delays added to a task of a complex schedule using a stochastic model for the complex schedule, delay information regarding a current delay associated with the task, and one or more defined mitigating actions that reduce or eliminate a delay component of the stochastic model;
a risk analysis component that determines loss information regarding losses associated with the time delays; and
a response recommendation component that determines a recommendation regarding implementation of the one or more defined mitigating actions based on the loss information and the probability distribution of the time delays.

2. The system of claim 1, wherein the response recommendation component further determines the recommendation regarding implementation of the one or more defined mitigating actions based on the probability distribution of the time delays.

3. The system of claim 1, wherein the delay component comprises a reactionary delay component that is function of end times of tasks preceding the task and a root-cause delay component that is an independent random process specific to a resource affecting the task at a specific time.

4. The system of claim 1, wherein the complex schedule comprises a plurality of interdependent tasks and wherein commencement of at least one or more first tasks of the plurality of interdependent tasks is dependent on completion of at least one or more second tasks of the plurality of interdependent tasks.

5. The system of claim 1, wherein the losses comprise costs, and wherein the loss information comprises a conditional probability distribution of the costs based on the probability distribution of the time delays.

6. The system of claim 1, wherein the delay forecasting component:
determines a probability distribution of start time delays added to a scheduled start time of the task using the stochastic model for the task, and based on the delay information, and the one or more defined mitigating actions; and
determines a probability distribution of end time delays added to a scheduled end time of the task using the stochastic model for the task, and based on the delay information, and the one or more defined mitigating actions.

7. The system of claim 6, wherein the risk analysis component determines the loss information based on start costs associated with the start time delays, end costs associated with the end time delays, and mitigation costs associated the one or more defined mitigating actions.

8. The system of claim 1, wherein the risk analysis component further determines a combination of the one or more defined mitigating actions that minimizes a risk measure of the losses.

9. The system of claim 8, wherein the response recommendation component recommends the combination of the one or more defined mitigating actions for implementation based on combination minimizing the losses.

10. The system of claim 8, wherein at least one mitigating action of the combination of the one or more defined mitigating actions corresponds to a cancelation of the task, and wherein the computer executable components further comprise:
an execution component that cancels the task and updates the complex schedule to reflect the cancelation of the task based on a determination that the cancelation of the task minimizes the losses.

11. The system of claim 8, wherein the risk analysis component employs a dynamical programming function to determine the mitigating action.

12. The system of claim 1, wherein the stochastic model comprises a Markov model.

13. The system of claim 12, wherein the Markov model was trained using a hidden Markov model based on historical schedule and delay data associated with the complex schedule.

14. The system of claim 1, wherein the task comprises flight of an aircraft from a first airport to a second airport and wherein the time delays comprise departure time delays to a scheduled departure time of the aircraft departing from the first airport, and arrival time delays added to a scheduled arrival time of the aircraft at the second airport.

15. A computer implemented method, comprising:
forecasting, by a device operatively coupled to a processor, probability distributions of time delays added to respective tasks of a complex schedule using a stochastic model for the respective tasks, current delay information associated with the respective tasks, and one or more defined mitigating actions that reduce or eliminate time delay attributed to a delay component of the stochastic model;
determining, by the device, loss information regarding losses associated with the time delays based on delay losses attributed to the time delays and mitigation losses attributed to the one or more defined mitigating actions; and
determining, by the device, a recommendation regarding implementation of the one or more defined mitigating actions based on the loss information.

16. The computer implemented method of claim 15, wherein the determining the recommendation further comprises determining the recommendation based on the probability distribution of the time delays.

17. The computer implemented method of claim 15, further comprising:
determining, by the device, a combination of the one or more defined mitigating actions that minimizes the losses.

18. The computer implemented method of claim 17, wherein the mitigating action comprises a change to a current or future task of the respective tasks, and wherein the computer implemented method further comprises:
based on the determining the mitigating action, controlling, by the device, current performance or future performance of the task based on the change.

19. A computer program product for controlling disruptions associated with complex schedules comprising a plurality of interdependent tasks, the computer program product comprising a computer readable storage medium having program instructions embodied therewith, the program instructions executable by a processing component to cause the processing component to:
forecast probability distributions of time delays added to scheduled start times and scheduled end times of respective tasks of the plurality of interdependent tasks;
determine loss information regarding losses associated with the time delays based on delay losses attributed to the time delays and mitigation losses attributed to the one or more defined mitigating actions; and
determine a recommendation regarding implementation of the one or more defined mitigating actions based on the loss information and the probability distributions of the time delays.

20. The computer program product of claim 19, wherein the program instructions executable by the processing component further cause the processing component to:
determine a mitigating action of the one or more defined mitigating action that minimizes the losses, wherein the mitigating action comprises a change to utilization of a resource associated with a task of the respective tasks; and
direct an entity to adapt performance of the task in to implement the change.
